(19) United States
(12) Patent Application Publication
(10) Pub. No.: US 2023/0394708 A1
(43) Pub. Date: Dec. 7, 2023

(54) METHODS, SYSTEMS, ARTICLES OF MANUFACTURE AND APPARATUS TO CALIBRATE IMAGING DEVICES

(71) Applicant: Intel Corporation, Santa Clara, CA (US)

(72) Inventors: Julio Cesar Zamora, West Sacramento, CA (US); Edgar Macías García, Guadalajara (MX); Leobardo Emmanuel Campos Macias, Guadalajara (MX); David Israel Gonzalez Aguirre, Hillsboro, OR (US)

(21) Appl. No.: 18/453,070

(22) Filed: Aug. 21, 2023

(51) Int. Cl. G06T 7/80; G06T 5/00; G06T 5/20; G06T 7/11; G06T 7/194; G06T 7/70; G06V 10/22; G06V 10/774

(52) U.S. Cl. CPC G06T 7/80; G06T 5/002; G06T 5/20; G06T 7/11; G06T 7/194; G06T 7/70; G06V 10/22; G06V 10/774; G06T 2207/30244; G06T 2207/20081

(57) ABSTRACT

Systems, apparatus, articles of manufacture, and methods are disclosed to calibrate imaging devices. An example apparatus includes interface circuitry, machine readable instructions, and programmable circuitry to at least one of instantiate or execute the machine readable instructions to segregate an image into regions. The example apparatus binarizes the image by associating a first one of the regions with a surface, and associating a second one of the regions with background objects. The example apparatus also generates a quadric corresponding to the surface, distinguishes a first quantity of pixels from a second quantity of pixels from the binarized image, the first quantity of pixels associated with the first one of the regions and the second quantity of pixels associated with the second one of the regions, adjusts parameters of the quadric based on the first quantity of the pixels, and calculates calibration parameters based on the adjusted parameters of the quadric.

### FIELD OF THE DISCLOSURE

This disclosure relates generally to calibration of mixed reality camera devices and, more particularly, to methods, systems, articles of manufacture and apparatus to calibrate imaging devices.

### BACKGROUND

In recent years, collaborative work environments have involved participants that are located in disparate locations. Meetings conducted may include some participants together in a physical location, such as a meeting room, while some participants are located in geographically separated locations with computing equipment that connects to the common meeting room for audio and/or video conferencing.

### BRIEF DESCRIPTION OF THE DRAWINGS

FIG. 1 is a block diagram of an example environment in which example calibration circuitry may operate to calibrate imaging devices.

FIG. 2 is a block diagram of an example implementation of the calibration circuitry of FIG. 1.

FIG. 3 is a block diagram of example image processing progression to generate a binarized image.

FIGS. 4A and 4B are a lateral view and a top view of a table, respectively, in which the camera is calibrated relative to the table.

FIG. 5 is a plane view of the table illustrating a defined center and orthogonal axis.

FIG. 6 is a lateral view of a room illustrating derived dimensions thereof.

FIGS. 7-10 are flowcharts representative of example machine readable instructions and/or example operations that may be executed, instantiated, and/or performed by example programmable circuitry to implement the calibration circuitry of FIG. 2.

FIG. 11 is a block diagram of an example processing platform including programmable circuitry structured to execute, instantiate, and/or perform the example machine readable instructions and/or perform the example operations of FIGS. 7-10 to implement the calibration circuitry of FIG. 2.

FIG. 12 is a block diagram of an example implementation of the programmable circuitry of FIG. 11.

FIG. 13 is a block diagram of another example implementation of the programmable circuitry of FIG. 11.

FIG. 14 is a block diagram of an example software/firmware/instructions distribution platform (e.g., one or more servers) to distribute software, instructions, and/or firmware (e.g., corresponding to the example machine readable instructions of FIGS. 7-10) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not necessarily to scale.

### DETAILED DESCRIPTION

Human collaboration techniques and systems include a wide variety of technological tools. When collaboration participants are geographically separated, audio and video camera techniques permit meetings to occur with visual aspects of participant(s) and/or object(s) show to other participants in such geographically separated locations. Some collaboration environments, such as meeting rooms, include cameras and/or headsets that permit participants to utilize mixed reality content with each other. Typically, headsets exhibit a degree of inconvenience, user learning curve challenges and excessive cost. Even in circumstances where headsets are not implemented when facilitating mixed reality content, cameras in the meeting room may require tedious and error prone calibration procedures. For instance, traditional camera calibration includes particular visual patterns to calibrate the camera before mixed reality features may be implemented. The particular visual patterns include checkboards and/or fiducial grids (e.g., printed on paper, card-stock, etc.) that have specific sizes and/or patterns, which may be specific to the camera manufacturer. In the event these visual grids are misplaced or damaged (e.g., coffee/drink stains, food stains, wear-and-tear (e.g., scratches, rips, tears, bends), fading), then camera calibration cannot be completed and/or the calibration techniques may cause erroneous mixed reality experiences. Additionally, protocols and procedures to utilize such visual patterns for calibration require user training, which detracts from productive collaborative meeting time. In some instances, the human actors do not properly place a visual calibration grid (e.g., fiducial grid) in the room during the calibration process, leading to poor mixed media performance. Further, traditional calibration techniques may need to occur at the onset of each mixed reality meeting session and/or if the meeting camera changes its position in the meeting room.

Examples disclosed herein facilitate automatic calibration techniques to transform a meeting room into an immersive space that facilitates mixed reality, thereby allowing participants to share collaborative content without imposing head-mounted devices and/or complicated calibration techniques. Examples disclosed herein generate a reference coordinate frame (e.g., a spatial/mathematical representation having an x-axis, a y-axis, a z-axis and/or rotational references) that is orthogonal to a meeting room table, in which the reference frame aligns with the camera to make it possible to insert virtual 4D content (e.g., dynamic 3D assets) within the collaborative scene. Example reference coordinate frame generation disclosed herein does not require specific visual patterns/grids that are specific to a particular camera manufacturer, but rather permit automatic calibration of off-the-shelf RGB cameras that are typically lower in cost as compared to specialized mixed reality cameras. Examples disclosed herein facilitate mixed reality content features on circular or substantially elliptical table surfaces and require readily available meeting room dimensional information and readily available intrinsic camera properties (e.g., focal length, resolution, etc.).

Examples disclosed herein perform automatic calibration of a camera based on a partial view of a circular or ellipsoid-shaped table in which a table diameter is known (or a major-axis dimension of an ellipsoid). In some such examples, the entire table surface view by the camera is not necessary (e.g., partial view table calibration).

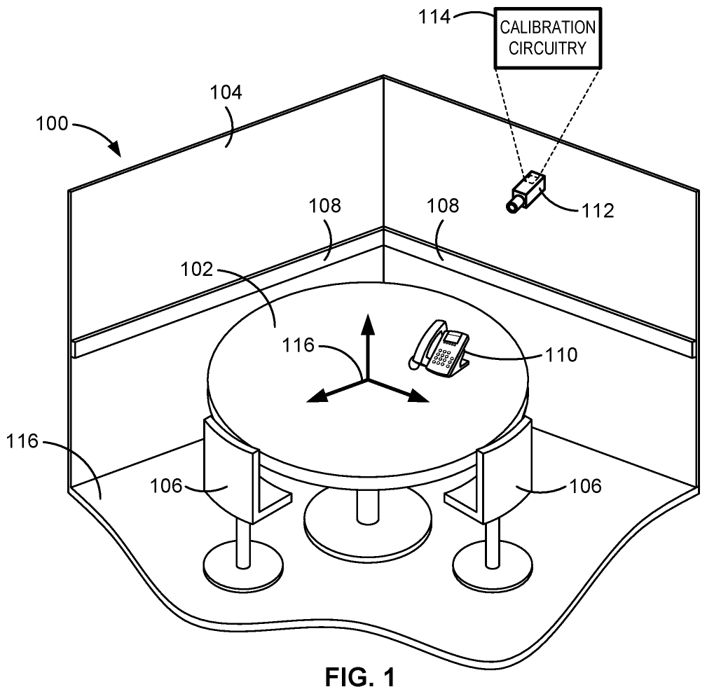

FIG. 1 is a diagram of an example environment 100 in which examples disclosed herein may be utilized. In the illustrated example of FIG. 1, the environment 100 is a conference room having walls 104, two of which are shown. The example environment 100 also includes a table 102, a chair 106, a wall rail guard 108, a phone 110 on the example table 102, and an example camera 112. While the illustrated example of FIG. 1 includes a single chair 106 and a single item (e.g., the phone 110) on the table 102, examples disclosed herein are not limited thereto, such that any number of items may be present in the example environment. Additionally, while the illustrated example of FIG. 1 includes the camera 112 attached to one of the example walls 104. In other examples the camera 112 may be positioned upon and/or otherwise mounted to any wall, a ceiling, a shelf, or a stand (e.g., a tri-pod stand). The illustrated example of FIG. 1 also includes calibration circuitry 114, which is shown proximate to the example camera 112. However, the example calibration circuitry 114 of FIG. 1 may be located anywhere that permits communicative connectivity to the example camera 112. In some examples the calibration circuitry 114 is located in a separate room having network connectivity to the camera 112, and in some examples the calibration circuitry 114 is located in a computing device within the environment 100 (e.g., a personal computer, a laptop, an Internet of Things (IoT) device, a server, etc.) and/or with the camera itself.

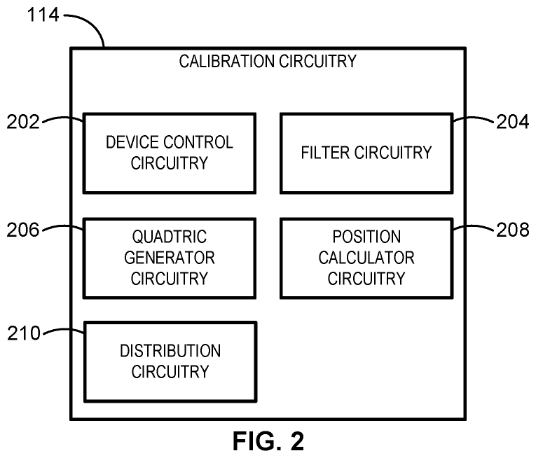

FIG. 2 is a block diagram of an example implementation of the calibration circuitry of FIG. 1. The calibration circuitry of FIG. 2 may be instantiated (e.g., creating an instance of, bring into being for any length of time, materialize, implement, etc.) by dedicated circuitry and/or by programmable circuitry such as a Central Processor Unit (CPU) executing first instructions. Additionally or alternatively, the calibration circuitry of FIG. 2 may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. It should be understood that some or all of the circuitry of FIG. 2 may, thus, be instantiated at the same or different times. Some or all of the circuitry of FIG. 2 may be instantiated, for example, in one or more threads executing concurrently on hardware and/or in series on hardware. Moreover, in some examples, some or all of the circuitry of FIG. 2 may be implemented by microprocessor circuitry executing instructions and/or FPGA circuitry performing operations to implement one or more virtual machines and/or containers.

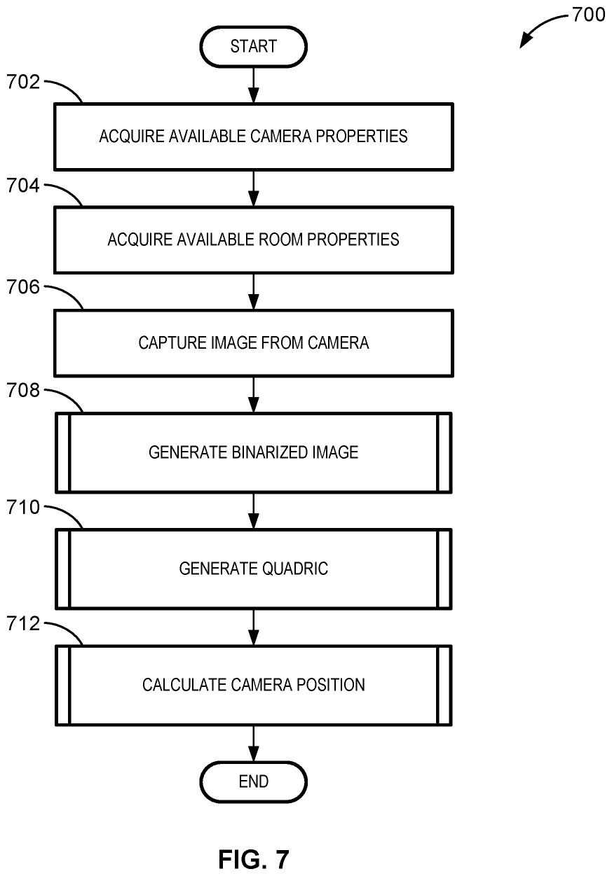

The example calibration circuitry 114 of FIG. 2 includes example device control circuitry 202, example filter circuitry 204, example quadric generator circuitry 206, example position calculator circuitry 208 and example distribution circuitry 210. As described in further detail below, the example device control circuitry 202 interacts with, interfaces with and/or otherwise controls imaging devices that may be used for collaboration, such as control of the example camera 112 of FIG. 1. In some examples, the device control circuitry 202 is instantiated by dedicated hardware circuitry and/or by programmable circuitry executing device control instructions and/or configured to perform operations such as those represented by the flowchart(s) of FIGS. 7-10. As described in further detail below, the example filter circuitry 204 applies and/or otherwise generates one or more filters to be used with images captured from the example camera 112 of FIG. 1.

In some examples, the filter circuitry 204 is instantiated by dedicated hardware circuitry and/or by programmable circuitry executing filter instructions and/or configured to perform operations such as those represented by the flowchart(s) of FIGS. 7-10. As described in further detail below, the example quadric generator circuitry 206 generates a quadric or other numeric representation of a table within the example environment 100, such as the example table 102 of FIG. 1. In some examples, the quadric generator circuitry 206 is instantiated by dedicated hardware circuitry and/or by programmable circuitry executing quadric generation instructions and/or configured to perform operations such as those represented by the flowchart(s) of FIGS. 7-10. As described in further detail below, the example position calculator circuitry 208 calculates and/or otherwise determines spatial information relative to the example camera 112 and the table 102 in view of a coordinate frame 116 (e.g., a spatial frame or mapping having an x-axis, a y-axis and a z-axis). In some examples, the position calculator circuitry 208 is instantiated by dedicated hardware circuitry and/or by programmable circuitry executing position calculation instructions and/or configured to perform operations such as those represented by the flowchart(s) of FIGS. 7-10. As described in further detail below, the example distribution circuitry 210 transmits and/or otherwise distributes calibration information to one or more computing devices that facilitate collaborative meeting services, such as mixed reality content. In some examples, the distribution circuitry 210 is instantiated by dedicated hardware circuitry and/or by programmable circuitry executing distribution instructions and/or configured to perform operations such as those represented by the flowchart(s) of FIGS. 7-10.

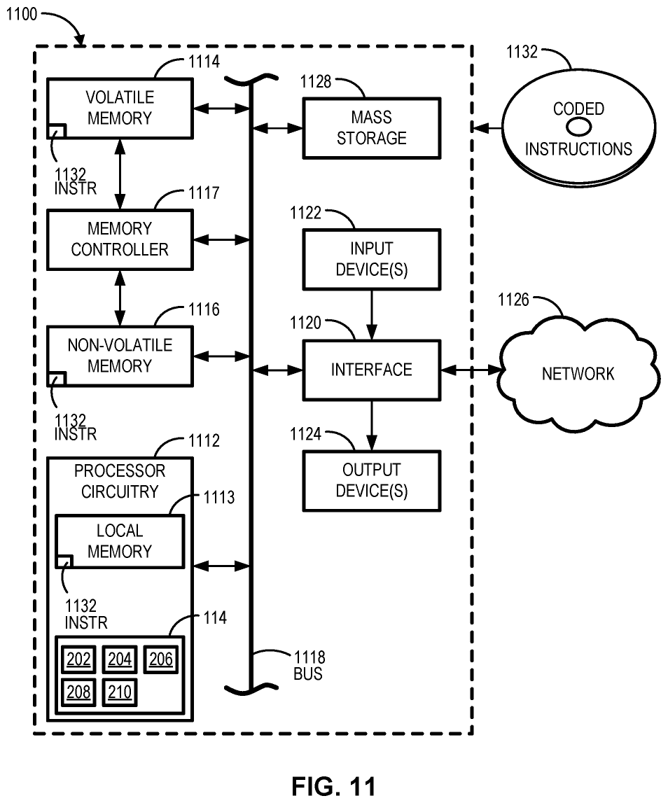

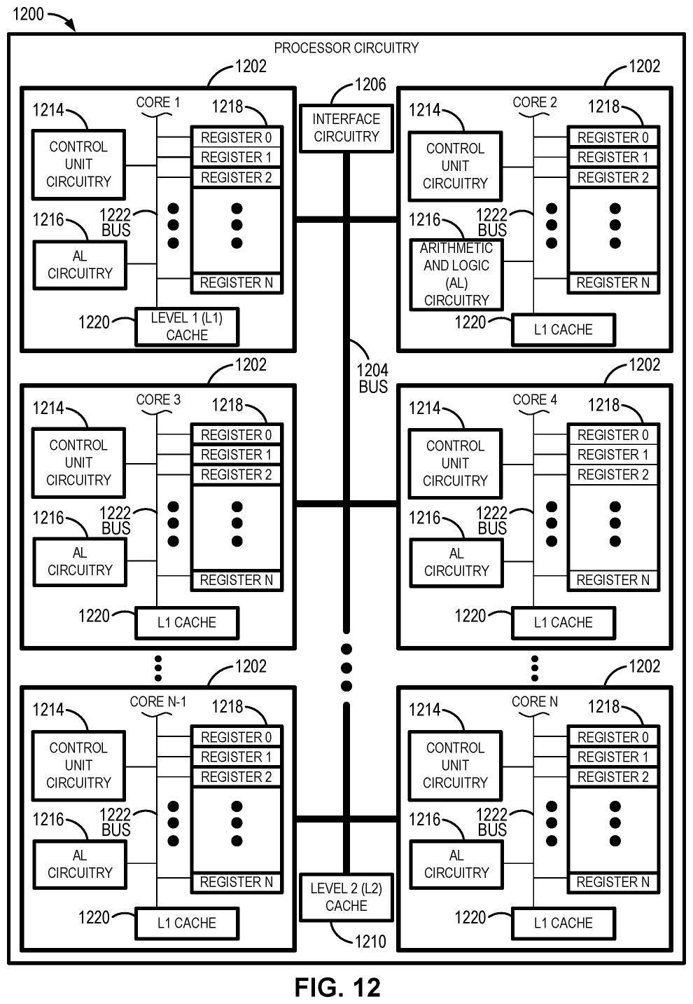

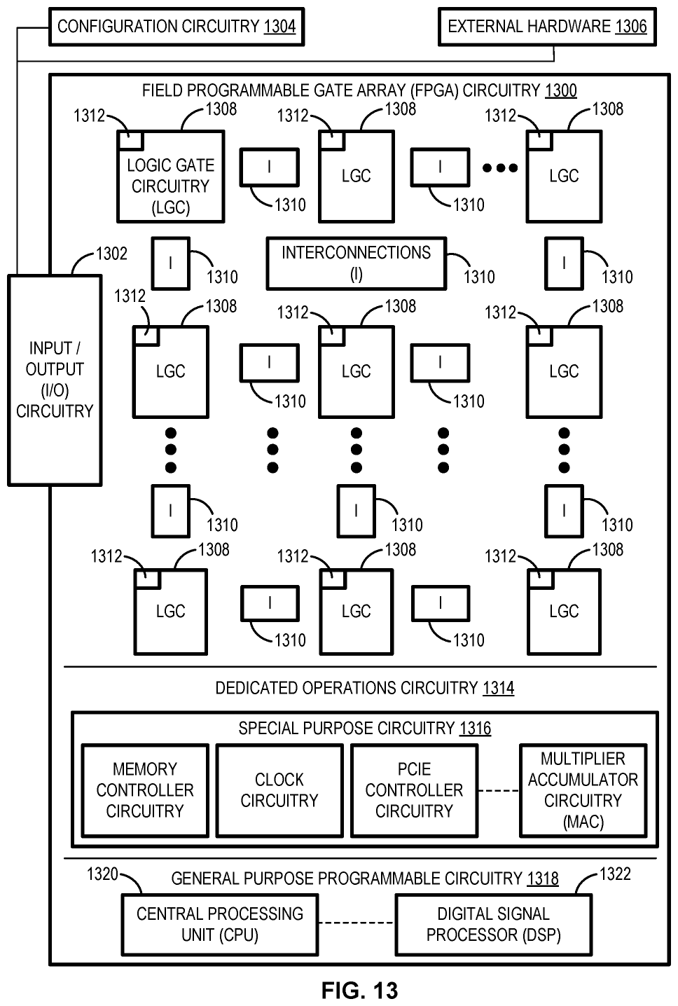

In some examples, the calibration circuitry includes means for controlling a device. For example, the means for controlling may be implemented by device control circuitry 202. In some examples, the device control circuitry 202 may be instantiated by programmable circuitry such as the example programmable circuitry 1112 of FIG. 11. For instance, the device control circuitry 202 may be instantiated by the example microprocessor 1200 of FIG. 12 executing machine executable instructions such as those implemented by at least blocks 702 through 712 of FIG. 7. In some examples, the device control circuitry 202 may be instantiated by hardware logic circuitry, which may be implemented by an ASIC, XPU, or the FPGA circuitry 1300 of FIG. 13 configured and/or structured to perform operations corresponding to the machine readable instructions. Additionally or alternatively, the device control circuitry 202 may be instantiated by any other combination of hardware, software, and/or firmware. For example, the device control circuitry 202 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In some examples, the calibration circuitry includes means for filtering. For example, the means for filtering may be implemented by filter circuitry 204. In some examples, the filter circuitry 204 may be instantiated by programmable circuitry such as the example programmable circuitry 1112 of FIG. 11. For instance, the filter circuitry 204 may be instantiated by the example microprocessor 1200 of FIG. 12 executing machine executable instructions such as those implemented by at least blocks 702 through 712 of FIG. 7. In some examples, the filter circuitry 204 may be instantiated by hardware logic circuitry, which may be implemented by an ASIC, XPU, or the FPGA circuitry 1300 of FIG. 13 configured and/or structured to perform operations corresponding to the machine readable instructions. Additionally or alternatively, the filter circuitry 204 may be instantiated by any other combination of hardware, software, and/or firmware. For example, the filter circuitry 204 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In some examples, the calibration circuitry includes means for generating a quadric. For example, the means for generating a quadric may be implemented by quadric generator circuitry 206. In some examples, the quadric generator circuitry 206 may be instantiated by programmable circuitry such as the example programmable circuitry 1112 of FIG. 11. For instance, the quadric generator circuitry 206 may be instantiated by the example microprocessor 1200 of FIG. 12 executing machine executable instructions such as those implemented by at least blocks 702 through 712 of FIG. 7. In some examples, the quadric generator circuitry 206 may be instantiated by hardware logic circuitry, which may be implemented by an ASIC, XPU, or the FPGA circuitry 1300 of FIG. 13 configured and/or structured to perform operations corresponding to the machine readable instructions. Additionally or alternatively, the quadric generator circuitry 206 may be instantiated by any other combination of hardware, software, and/or firmware. For example, the quadric generator circuitry 206 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In some examples, the calibration circuitry includes means for position determination. For example, the means for position determination may be implemented by position calculator circuitry 208. In some examples, the position calculator circuitry 208 may be instantiated by programmable circuitry such as the example programmable circuitry 1112 of FIG. 11. For instance, the position calculator circuitry 208 may be instantiated by the example microprocessor 1200 of FIG. 12 executing machine executable instructions such as those implemented by at least blocks 702 through 712 of FIG. 7. In some examples, the position calculator circuitry 208 may be instantiated by hardware logic circuitry, which may be implemented by an ASIC, XPU, or the FPGA circuitry 1300 of FIG. 13 configured and/or structured to perform operations corresponding to the machine readable instructions. Additionally or alternatively, the position calculator circuitry 208 may be instantiated by any other combination of hardware, software, and/or firmware. For example, the position calculator circuitry 208 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In some examples, the calibration circuitry includes means for distribution. For example, the means for distribution may be implemented by distribution circuitry 210. In some examples, the distribution circuitry 210 may be instantiated by programmable circuitry such as the example programmable circuitry 1112 of FIG. 11. For instance, the distribution circuitry 210 may be instantiated by the example microprocessor 1200 of FIG. 12 executing machine executable instructions such as those implemented by at least blocks 702 through 712 of FIG. 7. In some examples, the distribution circuitry 210 may be instantiated by hardware logic circuitry, which may be implemented by an ASIC, XPU, or the FPGA circuitry 1300 of FIG. 13 configured and/or structured to perform operations corresponding to the machine readable instructions. Additionally or alternatively, the distribution circuitry 210 may be instantiated by any other combination of hardware, software, and/or firmware. For example, the distribution circuitry 210 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In operation, the example calibration filter circuitry 114 facilitates a three-stage approach to calibrate an imaging device. In particular, the calibration filter circuitry 114 invokes device control circuitry 202 and filter circuitry 204 to generate a binarized image in a first stage, and invokes quadric generator circuitry 206 to generate and/or otherwise extract a quadric representation of an ellipsoid in a second stage, and finally invokes position calculator circuitry 208 to determine calibration information in a third stage, such as determining camera tilt metrics and camera pan metrics. The example device control circuitry 202 acquires available camera properties, such as a particular camera resolution and focal length. In some examples, the device control circuitry 202 instantiates an application programming interface (API) provided by a manufacturer of the camera 112 to extract such available camera device information. The example device control circuitry 202 also acquires available room properties, such as room dimensions (e.g., a room wall width, a room wall length, a ceiling height, etc.). In some examples, the device control circuitry 202 invokes distance measurement sensors of the camera 112, such as ultrasonic sensors that determine room dimension information.

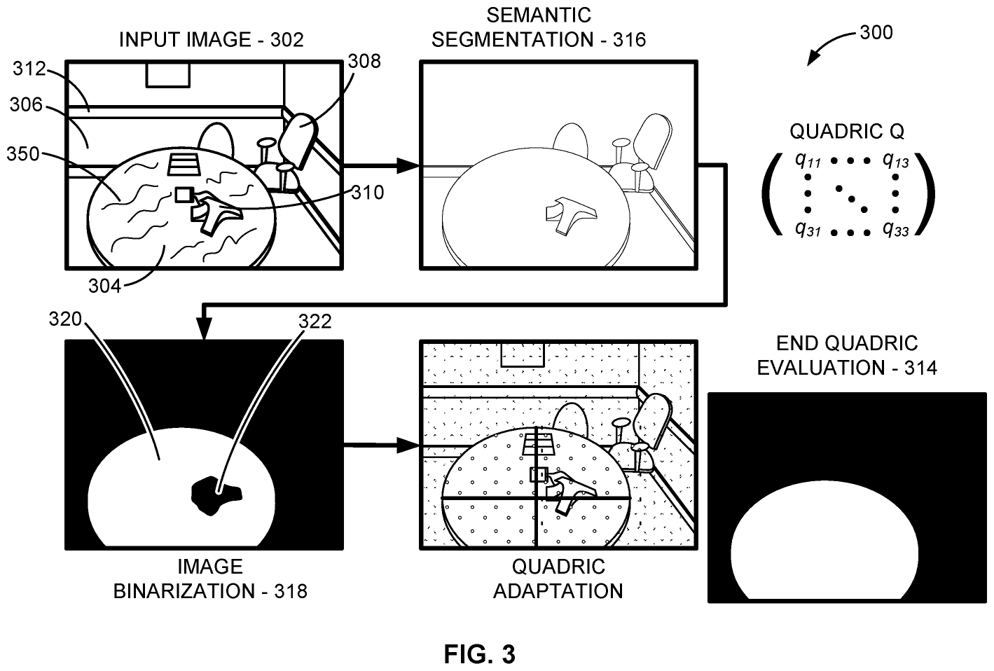

FIG. 3 is a block diagram of an example image processing progression 300 disclosed herein. The example device control circuitry 202 acquires an image 302 (e.g., a camera image captured by the example camera 112) of a room in which mixed media features are to be implemented. In the illustrated example of FIG. 3, the image 302 includes a view substantially similar to the environment 100 of FIG. 1, which includes a room having a table 102. As used herein, the example table 102 is a foreground object of any image captured by the camera 112, and all other objects are considered background objects. For example, the acquired image 302 of FIG. 3 includes a table 304, which is also referred to herein as a foreground object. The acquired image 302 of FIG. 3 also includes walls 306, chairs 308, desktop objects 310 (e.g., a conference phone, a pad of paper) and a rail guard 312, all of which are considered background objects or noise. While the human eye can appreciate portions of the image 302 that are the table as distinguished from non-table or background noise, examples disclosed herein modify the captured image 302 in an effort to create a binarized image 314 (also referred to herein as binarizing the camera image). In particular, the example binarized image 314 of FIG. 3 includes only two (binary) colors (sometimes referred to herein as class regions) (e.g., black to represent background pixels and white to represent foreground or table pixels). To achieve the example binarized image 314, the example filter circuitry 204 instantiates one or more techniques to segregate and/or otherwise distinguish different portions of a camera image captured by the camera into class regions (e.g., colors). In particular, the filter circuitry 204 applies a Gaussian blur filter to the captured image, the filter based on an acquired table color (e.g., class). In some examples, the filter circuitry 204 implements and/or otherwise applies a Gaussian blur modification of the captured image 302 using a 3×3 filter to smooth the captured image 302 and make the table 304 a homogeneous color. For instance, some table surfaces may exhibit a wood grain or other pattern 350 rather than a homogeneous or solid color (e.g., a non-homogenous characteristic of the class/color associated with the table). The application of the Gaussian blur filter mitigates non-homogeneous characteristics/artifacts of the table color (and/or pattern). For instance, while the wood grain or pattern 350 on the table 304 is initially seen if the input image 302, such wood grain and/or pattern 350 is not evident to the example image to the right (see the image labeled Semantic Segmentation 316).

The example filter circuitry 204 applies a mean-shift filter to segment objects within the captured (and blurred) image 302 to produce a segmented image 316. In some examples, the filter circuitry 204 uses a pyramidal filter as the mean-shift filter in which each pixel of an image (in which each pixel includes a spatial location and a particular color) is evaluated in connection with a set of neighboring pixels. Based on the set of neighboring pixels, a new spatial center value is calculated as a spatial mean and a new mean color value is calculated. Any number of mean-shift iterations can continue until a threshold metric of diminishing returns is detected by the filter circuitry 204. As a result, and as shown in the illustrated example of FIG. 3, the segmented image 316 includes relatively fewer background objects based on the application of the example mean-shift filter. In particular, the segmented image 316 no longer includes the rail guard 312, and there are fewer desktop objects 310. In other words, examples disclosed herein segregate the camera image into different class regions with the goal of associating a first one of the class regions with a table (e.g., foreground object), and associating second ones of the class regions with background objects (e.g., walls, floors, objects placed on the table, etc.). Additional improvements to the segmented image 316 are achieved by examples disclosed herein by the filter circuitry 204 converting the segmented image to an alternate color space as compared to an original color space of the image. In some examples, the filter circuitry 204 converts the segmented image to an HSV (Hue-Saturation-Value) color space. Generally speaking, the mean-shift and HSV conversion results in a reduced number of classifications or channels that approaches a binary result of only white and black pixel representations for foreground and background objects, respectively. In some examples, the filter circuitry 204 converts the segmented image to a hue color space without regard to one or more of a saturation (e.g., the saturation (S) component of HSV color space) and value (e.g., the value (V) component of HSV color space) color space. In some examples, the filter circuitry isolates the table color as a primary class (e.g., primary channel) and sets all other classes (e.g., to represent background objects) as a single alternate class (e.g., secondary channel). Stated differently, the filter circuitry 204 generates a binarized image 318 that includes only two classes (i.e., black and white). Worth noting is that the example binarized image 318 and the example binarized image 314 both represent a camera image with two classes (e.g., only two classes in the example), the former binarized image 318 still includes some background artifacts on the table surface (see background object 322). As disclosed in further detail below, quadric evaluation disclosed herein reduces some of these erroneous artifacts.

While the example filter circuitry 204 is able to remove most of the background objects that may be present within any captured image via the example first stage, some background artifacts may remain. In the illustrated example of FIG. 3, the binarized image 318 includes the table 320 as a substantially ellipsoidal shape, but it still includes background objects 322 within its border. The example second stage invokes the example quadric generator circuitry 206 to improve the binarized image and generate a numeric representation of the table so that calibration metrics can be calculated. The example quadric disclosed herein is a symmetric matrix that includes parameters to define the table.

In some examples, the quadric generator circuitry 206 trains a neural network. In some examples, the neural network is a single neuron to mimic template matching in which an ellipsoid shape is expected to include no background artifacts, unlike the binarized image that still includes some background artifacts. Generally speaking, the quadric generator circuitry 206 implements a mathematical model of an ellipsoid so that error is reduced (e.g., minimized) between an ideal ellipsoid with no artifacts and the binarized image. While evaluating every pixel of a captured image would be computationally prohibitive, examples disclosed herein identify a quantity of random pixels from the captured image for processing to determine whether they reside inside or outside the table.

The example quadric generator circuitry 206 generates a quadric (Q) in a manner consistent with example Equation 1.

$$Q = ( \begin{matrix}{Q}_{11} & ⋯ & {Q}_{13} \\ ⋮ & ⋱ & ⋮ \\ {Q}_{31} & ⋯ & {Q}_{33}\end{matrix} ) . \qquad Equation 1$$

In the illustrated example of Equation 1, the quadric generator circuitry 206 evaluates quadric parameters (e.g., Q₁₁, Q₁₂, Q₁₃, . . . , Q₃₃) (e.g., initially untrained parameters within the matrix (Q) above) based on an ellipsoid geometry. The quadric generator circuitry 206 acquires a random set of pixels from the binarized image to reduce a computational burden associated with camera calibration. In some examples, the quadric generator circuitry 206 randomly selects 10000 pixels from the image and tests each point to determine whether it resides on a surface of the quadric (e.g., on the table) or whether it resides beyond the surface of the quadric (e.g., outside the table). The quadric generator circuitry 206 performs a boundary-satisfaction test on the randomly acquired pixels to determine, distinguish and/or otherwise calculate whether each random pixel is located inside or outside a boundary of the ellipsoid. In some instances, the quadric generator circuitry 206 performs the boundary-satisfaction test using boundary-satisfaction rules (e.g., a boundary-satisfaction framework of rules) in a manner consistent with example Equations 2 and example Equation 3.

X^{T}QX=0 Equation 2.

X^{T}QX<0 Equation 3.

In the event the selected pixel satisfies example Equation 2 (zero), then it is located outside a boundary of the ellipsoid, thereby considered a background pixel. In the event the selected pixel satisfies example Equation 3 (a negative value), then it is located inside and/or otherwise on the surface of the ellipsoid, thereby considered a foreground pixel of the table.

The example quadric generator circuitry 206 evaluates pixel distance values in a manner consistent with example Equation 4.

$$f ( X ) = \frac{1}{1 + {e}^{{x}^{T}} QX} . \qquad Equation 4$$

In the illustrated example of Equation 4, the quadric generator circuitry 206 causes an activation function to add non-linearity for machine learning, in which X represents the pixel that has x and y coordinate values. The derivative of example Equation 4 yields a gradient descent in a manner consistent with example Equation 5.

Qᵢⱼ=Qᵢⱼ−δ_{Xi}Xⱼ Equation 5.

In the illustrated example of Equation 5, the quadric generator circuitry 206 effectively instantiates a training rule to adjust the parameters of the quadric Q. Generally speaking, the quadric generator circuitry 206 adjusts the parameters in the quadric frame by frame to reduce an error between the binarized image and an output of the training rule based on the randomly selected pixels and a network of six parameters, where δ represents a sensitivity in a manner consistent with example Equation 6.

δ=r(d−f)f(1−f) Equation 6.

In the illustrated example of Equation 6, r represents a learning rate and d represents a value indicative of whether the pixel of interest is either inside the quadric (a value of “1”) or outside the quadric (a value of “0”). As a result, the quadric is trained to yield a trained quadric for further use when determining calibration parameters. As discussed above, while one or more applied filters applied by the example filter circuitry 204 transforms an original captured image 302 to a binarized image 318, such filtering techniques may still exhibit background noise 322 in portions of an identified table. As such, the aforementioned machine learning tasks applied to the quadric reduce, remove (e.g., minimize) the background noise 322 so that the quadric errors are, likewise, reduced.

As described above, the example third stage when calibrating an image device (e.g., a camera) includes determining calibration information (e.g., calibration values, calibration parameters), such as determining camera tilt metrics and camera pan metrics. In operation, the example third stage is initiated by the example position calculator circuitry 208 by determining and/or otherwise calculating a center of the quadric (Q) in a manner consistent with example Equations 7 and 8.

$$\begin{matrix}h = {x}_{0} - {D}_{x} \frac{{Q}_{13}}{{Q}_{11}} . & Equation 7 \\ k = {y}_{0} + {D}_{y} \frac{{Q}_{23}}{{Q}_{22}} . & Equation 8\end{matrix}$$

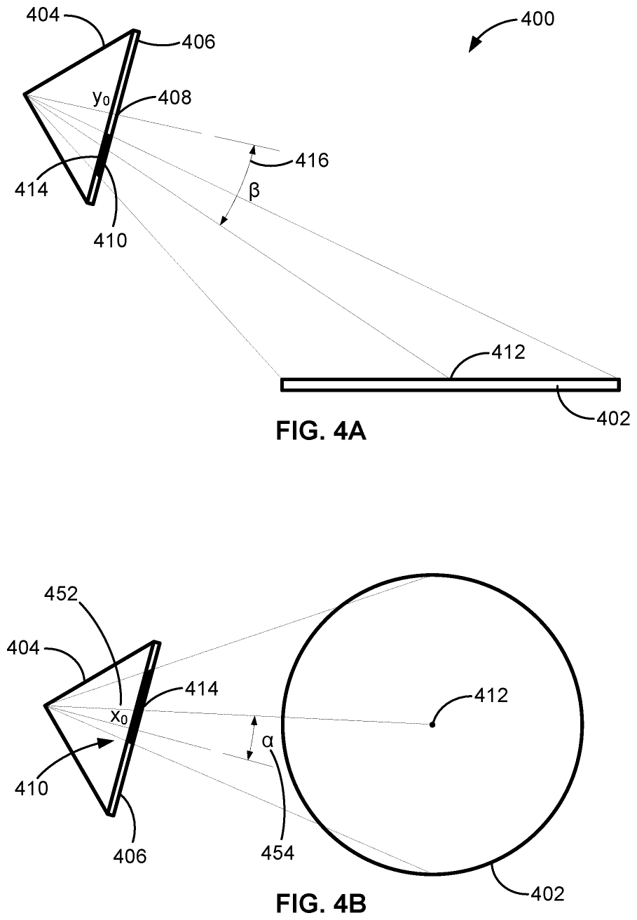

In the illustrated example of Equation 7 and Equation 8, h and k are coordinate points of the quadric (Q) indicative of its center, in which the center (h, k) is based on parameter values (Q_{xy}) of the quadric (Q). Additionally, x₀ and y₀ represent a center of the image corresponding to the intrinsic parameters of the camera (the camera's center), and Dₓ and D_{y} represent half of the size of a projected table, in which a lateral view the projected table is shown in FIG. 4A.

In the illustrated example of FIG. 4A, a lateral view 400 of a room table 402 and a camera 404 are shown. The example camera 404 includes an image plane 406 upon which image information (e.g., image objects) are captured and/or otherwise projected. The example image plane 406 of the camera 404 includes a camera y-axis center point (y₀) 408 that is based on the particular intrinsic properties of the camera 404. More specifically, the camera center point (y₀) 408 is the intersection of the orthogonal vector to the image plane 406. The illustrated example of FIG. 4A also shows that a portion of the image plane 406 includes a projected (e.g., a mapped) table 410. The example room table 402 includes a table center point 412, in which the center point 412 has a corresponding projected center point 414 of the projected table 410.

As described above, one of the calibration metrics of interest to be determined (e.g., so that mixed media features can be implemented by one or more mixed media systems) is a camera tilt with respect to the example table 402. To accomplish the determination of tilt, the example position calculator circuitry 208 first determines a lateral angle (β) 416 with respect to the projection of the center of the table 414 and the camera center point (y₀) 408 in a manner consistent with example Equation 9.

$$β = - atan ( \frac{{y}_{0} - k}{{f}_{y}} ) . \qquad Equation 9$$

In the illustrated example of Equation 9, f_{y} represents a focal length of the camera 404, which is one of the intrinsic properties of the camera previously acquired and/or otherwise determined by the device control circuitry 202. As described below, the lateral angle (β) 416 will assist in determining some calibration metrics (e.g., tilt metrics that can be used by mixed media systems to facilitate accurate virtual and/or augmented reality artifacts in collaborative environments).

As described above, camera 404 calibration parameters also include a pan metric. FIG. 4B is a top view 450 of the room table. In the illustrated example of FIG. 4B, similar structure to that shown in FIG. 4A includes the same reference numbers. The top view 450 of FIG. 4B includes the room table 402, the camera 404, an x-axis center point (x₀) 452 of the camera 404 that is based on the intrinsic properties of the camera 404, and the image plane 406 upon which image information (e.g., image objects) are captured and/or otherwise projected. Similar to FIG. 4A, the example image plane 406 includes a projected (e.g. a mapped) table 410. The example room table 402 includes a table center point 412, in which the center point 412 has a corresponding projected center point 414 of the projected table 410. To accomplish the determination of the pan metric, the example position calculator circuitry 208 determines a top angle (a) 454 with respect to the top-view projection of the center of the table 414 and the camera x-axis center point (x₀) 452 in a manner consistent with example Equation 10.

$$∝ = - atan ( \frac{{x}_{0} - h}{{f}_{x}} ) . \qquad Equation 10$$

In the illustrated example of Equation 10, fₓ represents a focal length of the camera, which is one of the intrinsic properties of the camera previously acquired and/or otherwise determined by the device control circuitry 202.

The example position calculator circuitry 208 determines and/or otherwise computes a radius (rₓ, r_{y}) of the Quadric (Q) on the x-axis and the y-axis in a manner consistent with example Equations 11a and 12a.

$${r}_{y} = {D}_{y} \frac{\begin{matrix}( {( {Q}_{12} {E}_{x} + {Q}_{23} )}^{2} - \\ {{Q}_{22} ( {Q}_{33} + {Q}_{11} {E}_{x}^{2} + 2 {Q}_{13} {E}_{x} ) )}^{\frac{1}{2}}\end{matrix}}{{Q}_{22}} . \qquad Equation 11 a$$

In the illustrated example of Equation 11a, Eₓ is represented in a manner consistent with example Equation 11b.

$${E}_{x} = \frac{h - {x}_{0}}{{k}_{1}} . \qquad Equation 11 b$$

To determine values for y when x=h, the value of y is solved in view of example Equation 11c.

$${q}_{11} {E}_{x}^{2} + 2 {q}_{12} {E}_{x} \frac{( {y}_{0} - y )}{{k}_{2}} + 2 {E}_{x} {q}_{13} + \frac{( {y}_{0} - y )}{{k}_{2}^{2}} {q}_{22} + 2 {q}_{23} \frac{( {y}_{0} - y )}{{k}_{2}} + {q}_{33} = 0. \qquad Equation 11 c$$

As a convenience, term A of example Equation 11d is defined to rewrite in a manner consistent with example Equation 11e, both of which are shown below.

$$\begin{matrix}A = \frac{( {y}_{0} - y )}{{k}_{2}} . & Equation 11 d \\ {A}^{2} + bA + c = 0 \{ \begin{matrix}a = {q}_{22} \\ b = 2 {q}_{12} {E}_{x} + 2 {q}_{23} \\ c = {q}_{11} {E}_{x}^{2} + 2 {E}_{x} {q}_{13} + {q}_{33}\end{matrix} . & Equation 11 e\end{matrix}$$

As shown above, the illustrated example of Equation 11e is quadratic and, as such, has two solutions.

$${y}_{1 , 2} = \frac{- b \pm \sqrt{{b}^{2} - 4 ac}}{2 a} . \qquad Equation 11 f$$

In the illustrated example of Equation 11f, the radial represents rₓ, which is factorized in a manner consistent with example Equation 11g to yield example Equation 11a.

$${r}_{y} = \frac{\sqrt{4 {( {q}_{12} {E}_{x} + {q}_{23} )}^{2} - 4 {q}_{22} ( {q}_{11} {E}_{x}^{2} + 2 {E}_{x} {q}_{13} + {q}_{33} )}}{2 {q}_{22}} . \qquad Equation 11 g$$

Similar to the example derivation above corresponding to Equation 11a, a similar derivation is described below in connection with Example Equation 12a.

$${r}_{x} = {D}_{x} \frac{\begin{matrix}( {( {Q}_{12} {E}_{y} + {Q}_{13} )}^{2} - \\ {{Q}_{11} ( {Q}_{33} + {Q}_{22} {E}_{y}^{2} + 2 {Q}_{23} {E}_{y} ) )}^{\frac{1}{2}}\end{matrix}}{{Q}_{11}} . \qquad Equation 12 a$$

In the illustrated example of Equation 12a, E_{y} is represented in a manner consistent with example Equation 12b.

$${E}_{y} = \frac{( {y}_{0} - k )}{{k}_{2}} . \qquad Equation 12 b$$

To determine values for x when y=k, the value of x is solved in view of example Equation 12c.

$${q}_{11} \frac{{( x - {x}_{0} )}^{2}}{{k}_{1}^{2}} + 2 {q}_{12} \frac{( x - {x}_{0} )}{{k}_{1}} \frac{( {y}_{0} - k )}{{k}_{2}} + 2 \frac{x - {x}_{0}}{{k}_{1}} {q}_{13} + \frac{{( {y}_{0} - k )}^{2}}{{k}_{2}^{2}} {q}_{22} + 2 {q}_{23} \frac{( {y}_{0} - k )}{{k}_{2}} + {q}_{33} = 0. \qquad Equation 12 c$$

As a convenience, term A of Example 12d is defined to rewrite in a manner consistent with example Equation 12e, both of which are shown below.

$$\begin{matrix}A = \frac{x - {x}_{0}}{{k}_{1}} . & Equation 12 d \\ {A}^{2} + bA + c = 0 \{ \begin{matrix}a = {q}_{11} \\ b = 2 {q}_{12} {E}_{y} + 2 {q}_{13} \\ c = {q}_{22} {E}_{y}^{2} + 2 {E}_{y} {q}_{23} + {q}_{33}\end{matrix} . & Equation 12 e\end{matrix}$$

As shown above, the illustrated example of Equation 12e is quadratic and, as such, has two solutions.

$${y}_{1 , 2} = \frac{- b \pm \sqrt{{b}^{2} - 4 ac}}{2 a} . \qquad Equation 12 f$$

In the illustrated example of Equation 12f, the radial represents rₓ, which is factorized in a manner consistent with example Equation 12g to yield example Equation 12a.

$${r}_{x} = \frac{\sqrt{4 {( {q}_{12} {E}_{y} + {q}_{13} )}^{2} - 4 {q}_{11} ( {q}_{22} {E}_{y}^{2} + 2 {E}_{y} {q}_{23} + {q}_{33} )}}{2 {q}_{11}} . \qquad Equation 12 g$$

To estimate the position of the camera, the position calculator circuitry 208 applies portions of the lateral angle (β) 416 and the top angle (α) 454 as example Equations 13 and 14 to generate a pan convenience term (lₓ) and a tilt convenience term (l_{y}).

lₓ=x₀−h Equation 13.

l_{y}=y₀−k Equation 14.

In the illustrated example of Equation 13, the pan convenience term (lₓ) is found in the numerator of example Equation 10, and the tilt convenience term (l_{y}) is found in the numerator of example Equation 9.

The example position calculator circuitry 208 accommodates for the possibility that the camera location could be located at any point on the surface of a sphere defined by the pan and tilt convenience terms. In particular, the position calculator circuitry 208 calculates the radius (N) of the sphere in a manner consistent with example Equation 15, which uses the recently derived radius of the quadric (rₓ).

$${N}^{2} = {R}^{2} \frac{( ( {f}_{x}^{2} + {( {l}_{x} - {r}_{x} )}^{2} ) ( {f}_{x}^{2} + {( {l}_{x} )}^{2} ) - {f}_{x}^{2} {r}_{x}^{2}}{{f}_{x}^{2} {r}_{x}^{2}} . \qquad Equation 15$$

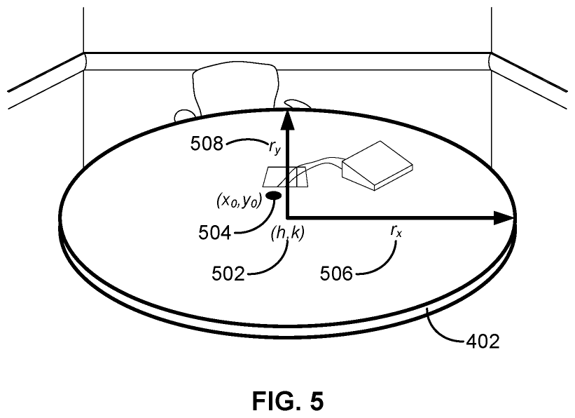

Examples disclosed herein presume that a shape of the room table 402 is that of an ellipsoid, which may include circular tables. As such, solutions for the possible locations for the camera position may be constrained by a plane defined by the center of the table, its orthogonal axis, and the camera center. FIG. 5 illustrates a candidate solution map 500 that includes the table 402 and the plane of the table 402 defined by the calculated center of the table (h, k) 502, the calculated center of the camera (x₀, y₀) 504, the x-axis radius of the quadric (rₓ) 506 and the y-axis radius of the quadric (r_{y}) 508. The example position calculator circuitry 208 reduces the candidate solution map 500 to a circle of possible solutions for the camera position using only two variables to define a height (Sₕ) and a distance (S_{d}) from the center of the camera in a manner consistent with example Equation 16.

Sₕ²=N²−S_{d}² Equation 16.

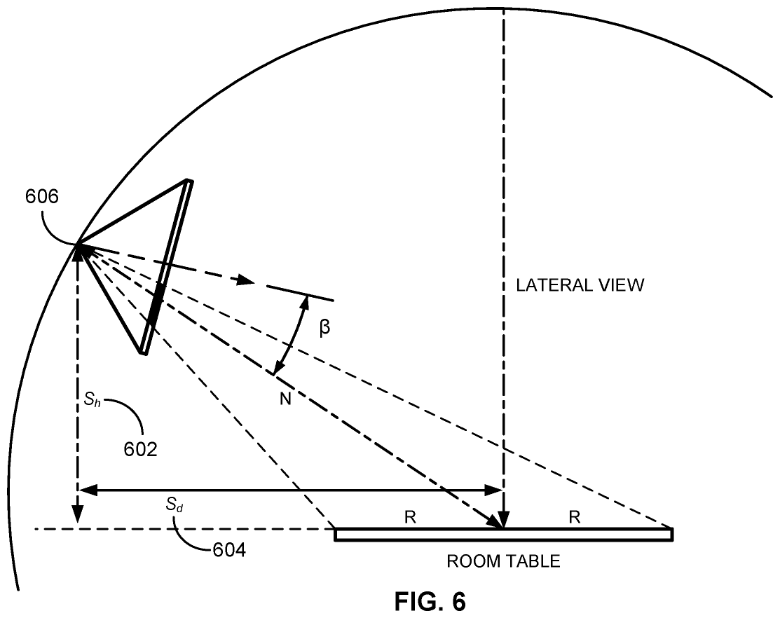

FIG. 6 illustrates a lateral view of the room 600 to illustrate the two variables that define the height (Sₕ) 602 and distance (S_{d}) 604 from a center of the camera 606. Based on the y-axis radius of the quadric (r_{y}), the example position calculator circuitry 208 generates a new constraint term in a manner consistent with example Equation 17.

$$\frac{{r}^{2} {S}_{h}^{2}}{{f}_{y}^{2} {r}_{y}^{2}} = \frac{( {S}_{h}^{2} + {( {S}_{d} - R )}^{2} ) ( {S}_{h}^{2} + {( {S}_{d} - R )}^{2} )}{( {f}_{y}^{2} + {( 2 {r}_{y} - {n}_{y} )}^{2} ) ( {f}_{y}^{2} + {n}_{y}^{2} )} . \qquad Equation 17$$

In the illustrated example of Equation 17, n_{y} is given by R, which represents the radius of the table. In particular, the new constraint ny is calculated by the position calculator circuitry 208 in a manner consistent with example Equation 18.

n_{y}=y₀−(k−r_{y}) Equation 18.

Using the new constraint n_{y} defined by example Equation 18, values of Sₕ and S_{d} are solved, and calibration metrics of tilt and pan are calculated by the position calculator circuitry 208 in a manner consistent with example Equations 19 and 20, respectively.

$$\begin{matrix}tilt = atan ( \frac{{l}_{y}}{{f}_{y}} ) + atan ( \frac{{S}_{h}}{{S}_{d}} ) . & Equation 19 \\ pan = atan ( \frac{{l}_{x}}{{f}_{x}} ) & Equation 20\end{matrix}$$

As such, examples disclosed herein generate calibration metrics of tilt and pan that are based on the geometry of the table in the room and the corresponding relative position and orientation of the camera.

While an example manner of implementing the calibration circuitry of FIG. 1 is illustrated in FIG. 2, one or more of the elements, processes, and/or devices illustrated in FIG. 2 may be combined, divided, re-arranged, omitted, eliminated, and/or implemented in any other way. Further, the example device control circuitry 202, the example filter circuitry 204, the example quadric generator circuitry 206, the example position calculator circuitry 208, the example distribution circuitry 210 and/or, more generally, the example calibration circuitry of FIG. 2, may be implemented by hardware alone or by hardware in combination with software and/or firmware. Thus, for example, any of the example device control circuitry 202, the example filter circuitry 204, the example quadric generator circuitry 206, the example position calculator circuitry 208, the example distribution circuitry 210, and/or, more generally, the example calibration circuitry, could be implemented by programmable circuitry in combination with machine readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), and/or field programmable logic device(s) (FPLD(s)) such as FPGAs. Further still, the example calibration circuitry of FIG. 2 may include one or more elements, processes, and/or devices in addition to, or instead of, those illustrated in FIG. 2, and/or may include more than one of any or all of the illustrated elements, processes and devices.

Flowchart(s) representative of example machine readable instructions, which may be executed by programmable circuitry to implement and/or instantiate the calibration circuitry of FIG. 2 and/or representative of example operations which may be performed by programmable circuitry to implement and/or instantiate the calibration circuitry of FIG. 2, are shown in FIGS. 7-10. The machine readable instructions may be one or more executable programs or portion(s) of one or more executable programs for execution by programmable circuitry such as the programmable circuitry 1112 shown in the example processor platform 1100 discussed below in connection with FIG. 11 and/or may be one or more function(s) or portion(s) of functions to be performed by the example programmable circuitry (e.g., an FPGA) discussed below in connection with FIGS. 12 and/or 13. In some examples, the machine readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer readable and/or machine readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer readable and/or machine readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowchart(s) illustrated in FIGS. 7-10, many other methods of implementing the example calibration circuitry may alternatively be used. For example, the order of execution of the blocks of the flowchart(s) may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). For example, the programmable circuitry may be a CPU and/or an FPGA located in the same package (e.g., the same integrated circuit (IC) package or in two or more separate housings), one or more processors in a single machine, multiple processors distributed across multiple servers of a server rack, multiple processors distributed across one or more server racks, etc., and/or any combination(s) thereof.

The machine readable instructions described herein may be stored in one or more of a compressed format, an encrypted format, a fragmented format, a compiled format, an executable format, a packaged format, etc. Machine readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine readable instructions may be fragmented and stored on one or more storage devices, disks and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable, computer readable and/or machine readable media, as used herein, may include instructions and/or program(s) regardless of the particular format or state of the machine readable instructions and/or program(s).

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example operations of FIGS. 7-10 may be implemented using executable instructions (e.g., computer readable and/or machine readable instructions) stored on one or more non-transitory computer readable and/or machine readable media. As used herein, the terms non-transitory computer readable medium, non-transitory computer readable storage medium, non-transitory machine readable medium, and/or non-transitory machine readable storage medium are expressly defined to include any type of computer readable storage device and/or storage disk and to exclude propagating signals and to exclude transmission media. Examples of such non-transitory computer readable medium, non-transitory computer readable storage medium, non-transitory machine readable medium, and/or non-transitory machine readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer readable storage device” and “non-transitory machine readable storage device” are defined to include any physical (mechanical, magnetic and/or electrical) hardware to retain information for a time period, but to exclude propagating signals and to exclude transmission media. Examples of non-transitory computer readable storage devices and/or non-transitory machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer-readable instructions, machine-readable instructions, etc.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

As used herein, unless otherwise stated, the term “above” describes the relationship of two parts relative to Earth. A first part is above a second part, if the second part has at least one part between Earth and the first part. Likewise, as used herein, a first part is “below” a second part when the first part is closer to the Earth than the second part. As noted above, a first part can be above or below a second part with one or more of: other parts therebetween, without other parts therebetween, with the first and second parts touching, or without the first and second parts being in direct contact with one another.

As used in this patent, stating that any part (e.g., a layer, film, area, region, or plate) is in any way on (e.g., positioned on, located on, disposed on, or formed on, etc.) another part, indicates that the referenced part is either in contact with the other part, or that the referenced part is above the other part with one or more intermediate part(s) located therebetween.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections as will be understood by persons of ordinary skill in the art. For example, “approximately” and “about” may indicate such dimensions may be within a tolerance range of +/−10% unless otherwise specified in the below description.

As used herein “substantially real time” refers to occurrence in a near instantaneous manner recognizing there may be real world delays for computing time, transmission, etc. Thus, unless otherwise specified, “substantially real time” refers to real time+1 second.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example an integrated circuit may be implemented as one or more of an ASIC, an FPGA, a chip, a microchip, programmable circuitry, a semiconductor substrate coupling multiple circuit elements, a system on chip (SoC), etc.

FIG. 7 is a flowchart representative of example machine readable instructions and/or example operations 700 that may be executed, instantiated, and/or performed by programmable circuitry to calibrate imaging devices. The example machine-readable instructions and/or the example operations 700 of FIG. 7 begin at block 702, at which the device control circuitry 202 acquires available camera properties. As described above, one or more intrinsic properties corresponding to the camera may be entered manually, or the device control circuitry 202 invokes and/or otherwise instantiates an API to query the camera to obtain such properties. Intrinsic properties corresponding to the camera include, but are not limited to a focal length of the camera, a resolution of the camera, and/or colors that the camera is capable of detecting. The example device control circuitry 202 also acquires available room properties (block 704). In some examples, the device control circuitry 202 invokes distance measurement sensors of the camera 112, such as ultrasonic sensors that determine room dimension information. The device control circuitry 202 captures one or more images from the camera (block 706) and stores the same to memory for further processing.

The example filter circuitry 204 generates a binarized image from the captured and/or stored image(s) (block 708). As described above, because the camera is able to capture any number of colors and/or gradients of color (e.g., shades, shadows, etc.), further processing of the image may require elevated amount of computational effort to distinguish the room table from other background noise. Background noise includes any non-table objects and/or image artifacts, such as walls, chairs, items mounted to the wall (e.g., paintings, pictures, signs, etc.) and/or items placed on the table (e.g., phones, laptops, phones, notepads, etc.). Because the example filter circuitry 204 modifies and/or otherwise augments the captured image to eliminate all except two colors, further processing of the image to identify table dimensions requires relatively less computational effort, as described above and in further detail below. As described above, generating the binarized image represents a first of three example stages to generate calibration metrics to facilitate mixed media features.

Based on the binarized image generated by the example filter circuitry 204, the example quadric generator circuitry 206 generates a quadric corresponding to the binarized image (block 710), which is a second of three example stages to generate calibration metrics to facilitate mixed media features. As described above, while the example filter circuitry 204 is able to remove most of the background objects that may be present within any captured image via the example first stage, some background artifacts may remain. The example second stage invokes the example quadric generator circuitry 206 to improve the binarized image and generate a numeric representation of the table, as described above and in further detail below.

As described above, the example third stage when calibrating an image device (e.g., a camera) includes the example position calculator circuitry 208 calculating a camera position (block 712) (e.g., determining calibration information), such as determining camera tilt metrics and camera pan metrics.

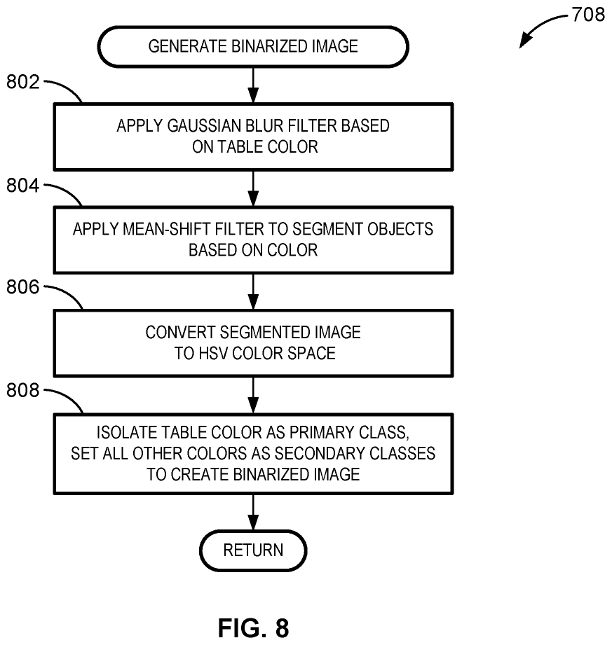

FIG. 8 is a flowchart of additional detail corresponding to generating a binarized image (block 708). In the illustrated example of FIG. 8, the filter circuitry 204 applies a Gaussian blur filter based on an acquired table color (block 802). To segment different objects within the captured and blurred image, the filter circuitry 204 applies a mean-shift filter (block 804). Additionally, the application of the mean-shift filter causes relatively fewer background objects to remain on the image, thereby improving an ability to distinguish and/or otherwise differentiate the table from background images. The filter circuitry 204 also converts the segmented image to an HSV color space (block 806) to further allow an isolation of the table color as a primary class and set all other colors to a secondary class (block 808). In effect, the isolation operation(s) reduce the number of distinct colors of the image to two (e.g., a primary channel to identify the table and a secondary channel to identify background objects). Control then returns to block 710 of FIG. 7.

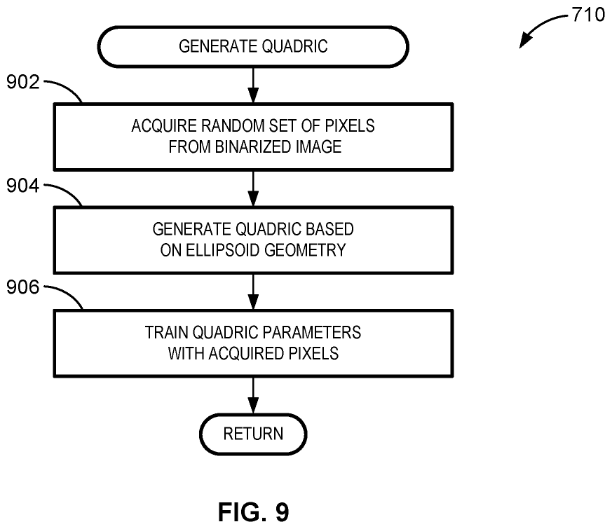

FIG. 9 is a flowchart of additional detail corresponding to generating the quadric (block 710). In the illustrated example of FIG. 9, the quadric generator circuitry 206 acquires a random set of pixels from the binarized image (block 902). Ones of the randomly selected pixels are analyzed to determine whether they reside within or external to the ellipsoid boundary, thereby indicating which pixels correspond to the table and which pixels correspond to background noise. By using an ellipsoid geometry (e.g., as a template), the quadric generator circuitry 206 generates a quadric (Q) (block 904), an example of which is discussed above in connection with example Equation 1. The example quadric generator circuitry 206 applies an activation function as a machine learning function to train quadric parameters using the randomly selected and labeled pixels (block 906). Control then returns to block 712 of FIG. 7.

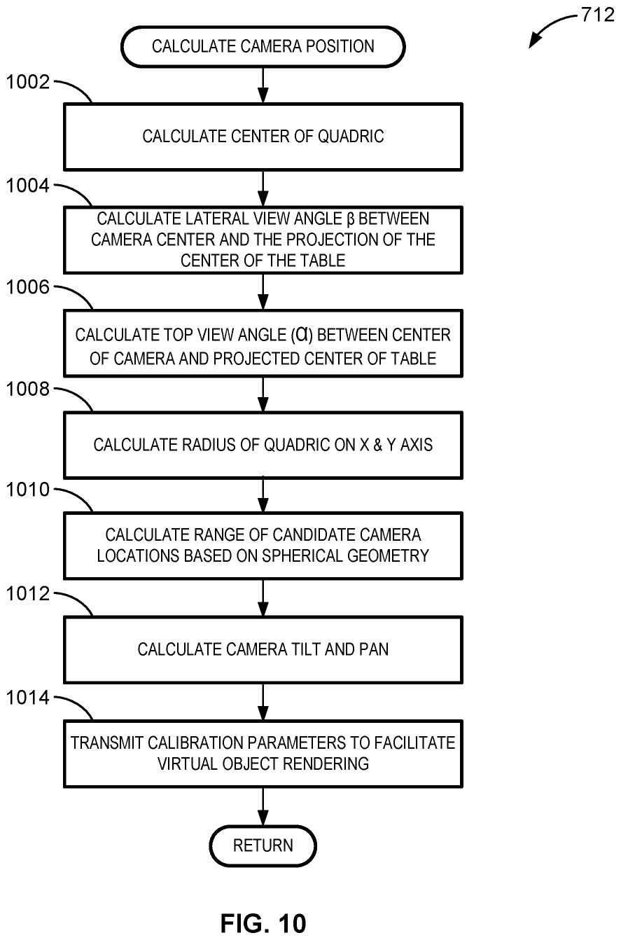

FIG. 10 is a flowchart including additional detail corresponding to calculating a camera position of block 712. In the illustrated example of FIG. 10, the position calculator circuitry 208 calculates a center of the quadric (block 1002). As described above, the position calculator circuitry 208 calculates the center of the quadric (h, k) in a manner consistent with example Equations 7 and 8. The position calculator circuitry 208 calculates a lateral view angle (β) between a camera center and the projection of the center of the table (block 1004), as described above in connection with example Equation 9 and FIG. 4A. The position calculator circuitry 208 also calculates a top view angle (α) between the center of the camera and a projected center of the table (block 1006), as described above in connection with example Equation 10 and FIG. 4B.

The example position calculator circuitry 208 calculates a radius of the quadric (Q) on an X and Y axis in a manner consistent with example Equations 11 and 12 above (block 1008). The radius of the quadric further enables the position calculator circuitry 208 to determine a range of candidate camera locations based on an assumed spherical geometry in a manner consistent with example Equations 15 through 18 (block 1010). The example position calculator circuitry 208 then calculates a camera tilt metric and a camera pan metric (block 1012), which is transmitted and/or otherwise provided to visualization systems to enable mixed media feature delivery (block 1014).

FIG. 11 is a block diagram of an example programmable circuitry platform 1100 structured to execute and/or instantiate the example machine-readable instructions and/or the example operations of FIGS. 7-10 to implement the calibration circuitry of FIG. 2. The programmable circuitry platform 1100 can be, for example, a server, a personal computer, a workstation, a self-learning machine (e.g., a neural network), a mobile device (e.g., a cell phone, a smart phone, a tablet such as an iPad™), an Internet appliance, a gaming console, a headset (e.g., an augmented reality (AR) headset, a virtual reality (VR) headset, etc.) or other wearable device, or any other type of computing and/or electronic device.

The programmable circuitry platform 1100 of the illustrated example includes programmable circuitry 1112. The programmable circuitry 1112 of the illustrated example is hardware. For example, the programmable circuitry 1112 can be implemented by one or more integrated circuits, logic circuits, FPGAs, microprocessors, CPUs, GPUs, DSPs, and/or microcontrollers from any desired family or manufacturer. The programmable circuitry 1112 may be implemented by one or more semiconductor based (e.g., silicon based) devices. In this example, the programmable circuitry 1112 implements the device control circuitry 202, the filter circuitry 204, the quadric generator circuitry 206, the position calculator circuitry 208, and the distribution circuitry 210.

The programmable circuitry 1112 of the illustrated example includes a local memory 1113 (e.g., a cache, registers, etc.). The programmable circuitry 1112 of the illustrated example is in communication with main memory 1114, 1116, which includes a volatile memory 1114 and a non-volatile memory 1116, by a bus 1118. The volatile memory 1114 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 1116 may be implemented by flash memory and/or any other desired type of memory device. Access to the main memory 1114, 1116 of the illustrated example is controlled by a memory controller 1117. In some examples, the memory controller 1117 may be implemented by one or more integrated circuits, logic circuits, microcontrollers from any desired family or manufacturer, or any other type of circuitry to manage the flow of data going to and from the main memory 1114, 1116.

The programmable circuitry platform 1100 of the illustrated example also includes interface circuitry 1120. The interface circuitry 1120 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 1122 are connected to the interface circuitry 1120. The input device(s) 1122 permit(s) a user (e.g., a human user, a machine user, etc.) to enter data and/or commands into the programmable circuitry 1112. The input device(s) 1122 can be implemented by, for example, an audio sensor, a microphone, a camera (still or video), a keyboard, a button, a mouse, a touchscreen, a trackpad, a trackball, an isopoint device, and/or a voice recognition system.

One or more output devices 1124 are also connected to the interface circuitry 1120 of the illustrated example. The output device(s) 1124 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 1120 of the illustrated example, thus, typically includes a graphics driver card, a graphics driver chip, and/or graphics processor circuitry such as a GPU.

The interface circuitry 1120 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 1126. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 1100 of the illustrated example also includes one or more mass storage discs or devices 1128 to store firmware, software, and/or data. Examples of such mass storage discs or devices 1128 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine readable instructions 1132, which may be implemented by the machine readable instructions of FIGS. 7-10, may be stored in the mass storage device 1128, in the volatile memory 1114, in the non-volatile memory 1116, and/or on at least one non-transitory computer readable storage medium such as a CD or DVD which may be removable.

FIG. 12 is a block diagram of an example implementation of the programmable circuitry 1112 of FIG. 11. In this example, the programmable circuitry 1112 of FIG. 11 is implemented by a microprocessor 1200. For example, the microprocessor 1200 may be a general-purpose microprocessor (e.g., general-purpose microprocessor circuitry). The microprocessor 1200 executes some or all of the machine-readable instructions of the flowcharts of FIGS. 7-10 to effectively instantiate the circuitry of FIG. 2 as logic circuits to perform operations corresponding to those machine readable instructions. In some such examples, the circuitry of FIG. 2 is instantiated by the hardware circuits of the microprocessor 1200 in combination with the machine-readable instructions. For example, the microprocessor 1200 may be implemented by multi-core hardware circuitry such as a CPU, a DSP, a GPU, an XPU, etc. Although it may include any number of example cores 1202 (e.g., 1 core), the microprocessor 1200 of this example is a multi-core semiconductor device including N cores. The cores 1202 of the microprocessor 1200 may operate independently or may cooperate to execute machine readable instructions. For example, machine code corresponding to a firmware program, an embedded software program, or a software program may be executed by one of the cores 1202 or may be executed by multiple ones of the cores 1202 at the same or different times. In some examples, the machine code corresponding to the firmware program, the embedded software program, or the software program is split into threads and executed in parallel by two or more of the cores 1202. The software program may correspond to a portion or all of the machine readable instructions and/or operations represented by the flowcharts of FIGS. 7-10.

The cores 1202 may communicate by a first example bus 1204. In some examples, the first bus 1204 may be implemented by a communication bus to effectuate communication associated with one(s) of the cores 1202. For example, the first bus 1204 may be implemented by at least one of an Inter-Integrated Circuit (I2C) bus, a Serial Peripheral Interface (SPI) bus, a PCI bus, or a PCIe bus. Additionally or alternatively, the first bus 1204 may be implemented by any other type of computing or electrical bus. The cores 1202 may obtain data, instructions, and/or signals from one or more external devices by example interface circuitry 1206. The cores 1202 may output data, instructions, and/or signals to the one or more external devices by the interface circuitry 1206. Although the cores 1202 of this example include example local memory 1220 (e.g., Level 1 (L1) cache that may be split into an L1 data cache and an L1 instruction cache), the microprocessor 1200 also includes example shared memory 1210 that may be shared by the cores (e.g., Level 2 (L2 cache)) for high-speed access to data and/or instructions. Data and/or instructions may be transferred (e.g., shared) by writing to and/or reading from the shared memory 1210. The local memory 1220 of each of the cores 1202 and the shared memory 1210 may be part of a hierarchy of storage devices including multiple levels of cache memory and the main memory (e.g., the main memory 1114, 1116 of FIG. 11). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 1202 may be referred to as a CPU, DSP, GPU, etc., or any other type of hardware circuitry. Each core 1202 includes control unit circuitry 1214, arithmetic and logic (AL) circuitry (sometimes referred to as an ALU) 1216, a plurality of registers 1218, the local memory 1220, and a second example bus 1222. Other structures may be present. For example, each core 1202 may include vector unit circuitry, single instruction multiple data (SIMD) unit circuitry, load/store unit (LSU) circuitry, branch/jump unit circuitry, floating-point unit (FPU) circuitry, etc. The control unit circuitry 1214 includes semiconductor-based circuits structured to control (e.g., coordinate) data movement within the corresponding core 1202. The AL circuitry 1216 includes semiconductor-based circuits structured to perform one or more mathematic and/or logic operations on the data within the corresponding core 1202. The AL circuitry 1216 of some examples performs integer based operations. In other examples, the AL circuitry 1216 also performs floating-point operations. In yet other examples, the AL circuitry 1216 may include first AL circuitry that performs integer-based operations and second AL circuitry that performs floating-point operations. In some examples, the AL circuitry 1216 may be referred to as an Arithmetic Logic Unit (ALU).

The registers 1218 are semiconductor-based structures to store data and/or instructions such as results of one or more of the operations performed by the AL circuitry 1216 of the corresponding core 1202. For example, the registers 1218 may include vector register(s), SIMD register(s), general-purpose register(s), flag register(s), segment register(s), machine-specific register(s), instruction pointer register(s), control register(s), debug register(s), memory management register(s), machine check register(s), etc. The registers 1218 may be arranged in a bank as shown in FIG. 12. Alternatively, the registers 1218 may be organized in any other arrangement, format, or structure, such as by being distributed throughout the core 1202 to shorten access time. The second bus 1222 may be implemented by at least one of an I2C bus, a SPI bus, a PCI bus, or a PCIe bus.

Each core 1202 and/or, more generally, the microprocessor 1200 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 1200 is a semiconductor device fabricated to include many transistors interconnected to implement the structures described above in one or more integrated circuits (ICs) contained in one or more packages.

The microprocessor 1200 may include and/or cooperate with one or more accelerators (e.g., acceleration circuitry, hardware accelerators, etc.). In some examples, accelerators are implemented by logic circuitry to perform certain tasks more quickly and/or efficiently than can be done by a general-purpose processor. Examples of accelerators include ASICs and FPGAs such as those discussed herein. A GPU, DSP and/or other programmable device can also be an accelerator. Accelerators may be on-board the microprocessor 1200, in the same chip package as the microprocessor 1200 and/or in one or more separate packages from the microprocessor 1200.

FIG. 13 is a block diagram of another example implementation of the programmable circuitry 1112 of FIG. 11. In this example, the programmable circuitry 1112 is implemented by FPGA circuitry 1300. For example, the FPGA circuitry 1300 may be implemented by an FPGA. The FPGA circuitry 1300 can be used, for example, to perform operations that could otherwise be performed by the example microprocessor 1200 of FIG. 12 executing corresponding machine readable instructions. However, once configured, the FPGA circuitry 1300 instantiates the operations and/or functions corresponding to the machine readable instructions in hardware and, thus, can often execute the operations/functions faster than they could be performed by a general-purpose microprocessor executing the corresponding software.

More specifically, in contrast to the microprocessor 1200 of FIG. 12 described above (which is a general purpose device that may be programmed to execute some or all of the machine readable instructions represented by the flowchart(s) of FIGS. 7-10 but whose interconnections and logic circuitry are fixed once fabricated), the FPGA circuitry 1300 of the example of FIG. 13 includes interconnections and logic circuitry that may be configured, structured, programmed, and/or interconnected in different ways after fabrication to instantiate, for example, some or all of the operations/functions corresponding to the machine readable instructions represented by the flowchart(s) of FIGS. 7-10. In particular, the FPGA circuitry 1300 may be thought of as an array of logic gates, interconnections, and switches. The switches can be programmed to change how the logic gates are interconnected by the interconnections, effectively forming one or more dedicated logic circuits (unless and until the FPGA circuitry 1300 is reprogrammed). The configured logic circuits enable the logic gates to cooperate in different ways to perform different operations on data received by input circuitry. Those operations may correspond to some or all of the instructions (e.g., the software and/or firmware) represented by the flowchart(s) of FIGS. 7-10. As such, the FPGA circuitry 1300 may be configured and/or structured to effectively instantiate some or all of the operations/functions corresponding to the machine readable instructions of the flowchart(s) of FIGS. 7-10 as dedicated logic circuits to perform the operations/functions corresponding to those software instructions in a dedicated manner analogous to an ASIC. Therefore, the FPGA circuitry 1300 may perform the operations/functions corresponding to the some or all of the machine readable instructions of FIGS. 7-10 faster than the general-purpose microprocessor can execute the same.

In the example of FIG. 13, the FPGA circuitry 1300 is configured and/or structured in response to being programmed (and/or reprogrammed one or more times) based on a binary file. In some examples, the binary file may be compiled and/or generated based on instructions in a hardware description language (HDL) such as Lucid, Very High Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 1300 of FIG. 13 may access and/or load the binary file to cause the FPGA circuitry 1300 of FIG. 13 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1300 of FIG. 13 to cause configuration and/or structuring of the FPGA circuitry 1300 of FIG. 13, or portion(s) thereof.

In some examples, the binary file is compiled, generated, transformed, and/or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is compiled, generated, and/or otherwise output from the uniform software platform based on the second instructions. In some examples, the FPGA circuitry 1300 of FIG. 13 may access and/or load the binary file to cause the FPGA circuitry 1300 of FIG. 13 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1300 of FIG. 13 to cause configuration and/or structuring of the FPGA circuitry 1300 of FIG. 13, or portion(s) thereof.

The FPGA circuitry 1300 of FIG. 13, includes example input/output (I/O) circuitry 1302 to obtain and/or output data to/from example configuration circuitry 1304 and/or external hardware 1306. For example, the configuration circuitry 1304 may be implemented by interface circuitry that may obtain a binary file, which may be implemented by a bit stream, data, and/or machine-readable instructions, to configure the FPGA circuitry 1300, or portion(s) thereof. In some such examples, the configuration circuitry 1304 may obtain the binary file from a user, a machine (e.g., hardware circuitry (e.g., programmable or dedicated circuitry) that may implement an Artificial Intelligence/Machine Learning (AI/ML) model to generate the binary file), etc., and/or any combination(s) thereof). In some examples, the external hardware 1306 may be implemented by external hardware circuitry. For example, the external hardware 1306 may be implemented by the microprocessor 1200 of FIG. 12.

The FPGA circuitry 1300 also includes an array of example logic gate circuitry 1308, a plurality of example configurable interconnections 1310, and example storage circuitry 1312. The logic gate circuitry 1308 and the configurable interconnections 1310 are configurable to instantiate one or more operations/functions that may correspond to at least some of the machine readable instructions of FIGS. 7-10 and/or other desired operations. The logic gate circuitry 1308 shown in FIG. 13 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 1308 to enable configuration of the electrical structures and/or the logic gates to form circuits to perform desired operations/functions. The logic gate circuitry 1308 may include other electrical structures such as look-up tables (LUTs), registers (e.g., flip-flops or latches), multiplexers, etc.

The configurable interconnections 1310 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1308 to program desired logic circuits.

The storage circuitry 1312 of the illustrated example is structured to store result(s) of the one or more of the operations performed by corresponding logic gates. The storage circuitry 1312 may be implemented by registers or the like. In the illustrated example, the storage circuitry 1312 is distributed amongst the logic gate circuitry 1308 to facilitate access and increase execution speed.

The example FPGA circuitry 1300 of FIG. 13 also includes example dedicated operations circuitry 1314. In this example, the dedicated operations circuitry 1314 includes special purpose circuitry 1316 that may be invoked to implement commonly used functions to avoid the need to program those functions in the field. Examples of such special purpose circuitry 1316 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 1300 may also include example general purpose programmable circuitry 1318 such as an example CPU 1320 and/or an example DSP 1322. Other general purpose programmable circuitry 1318 may additionally or alternatively be present such as a GPU, an XPU, etc., that can be programmed to perform other operations.

Although FIGS. 12 and 13 illustrate two example implementations of the programmable circuitry 1112 of FIG. 11, many other approaches are contemplated. For example, FPGA circuitry may include an on-board CPU, such as one or more of the example CPU 1320 of FIG. 12. Therefore, the programmable circuitry 1112 of FIG. 11 may additionally be implemented by combining at least the example microprocessor 1200 of FIG. 12 and the example FPGA circuitry 1300 of FIG. 13. In some such hybrid examples, one or more cores 1202 of FIG. 12 may execute a first portion of the machine readable instructions represented by the flowchart(s) of FIGS. 7-10 to perform first operation(s)/function(s), the FPGA circuitry 1300 of FIG. 13 may be configured and/or structured to perform second operation(s)/function(s) corresponding to a second portion of the machine readable instructions represented by the flowcharts of FIGS. 7-10, and/or an ASIC may be configured and/or structured to perform third operation(s)/function(s) corresponding to a third portion of the machine readable instructions represented by the flowcharts of FIGS. 7-10.

It should be understood that some or all of the circuitry of FIG. 2 may, thus, be instantiated at the same or different times. For example, same and/or different portion(s) of the microprocessor 1200 of FIG. 12 may be programmed to execute portion(s) of machine-readable instructions at the same and/or different times. In some examples, same and/or different portion(s) of the FPGA circuitry 1300 of FIG. 13 may be configured and/or structured to perform operations/functions corresponding to portion(s) of machine-readable instructions at the same and/or different times.

In some examples, some or all of the circuitry of FIG. 2 may be instantiated, for example, in one or more threads executing concurrently and/or in series. For example, the microprocessor 1200 of FIG. 12 may execute machine readable instructions in one or more threads executing concurrently and/or in series. In some examples, the FPGA circuitry 1300 of FIG. 13 may be configured and/or structured to carry out operations/functions concurrently and/or in series. Moreover, in some examples, some or all of the circuitry of FIG. 2 may be implemented within one or more virtual machines and/or containers executing on the microprocessor 1200 of FIG. 12.

In some examples, the programmable circuitry 1112 of FIG. 11 may be in one or more packages. For example, the microprocessor 1200 of FIG. 12 and/or the FPGA circuitry 1300 of FIG. 13 may be in one or more packages. In some examples, an XPU may be implemented by the programmable circuitry 1112 of FIG. 11, which may be in one or more packages. For example, the XPU may include a CPU (e.g., the microprocessor 1200 of FIG. 12, the CPU 1320 of FIG. 13, etc.) in one package, a DSP (e.g., the DSP 1322 of FIG. 13) in another package, a GPU in yet another package, and an FPGA (e.g., the FPGA circuitry 1300 of FIG. 13) in still yet another package.

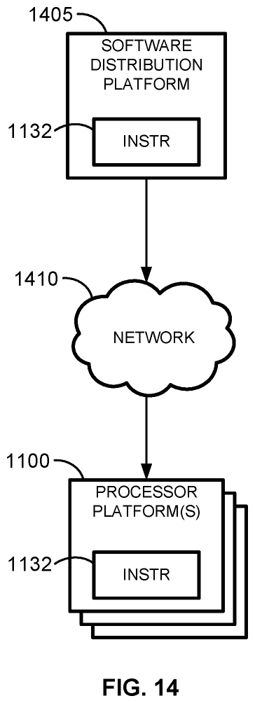

A block diagram illustrating an example software distribution platform 1405 to distribute software such as the example machine readable instructions 1132 of FIG. 11 to other hardware devices (e.g., hardware devices owned and/or operated by third parties from the owner and/or operator of the software distribution platform) is illustrated in FIG. 14. The example software distribution platform 1405 may be implemented by any computer server, data facility, cloud service, etc., capable of storing and transmitting software to other computing devices. The third parties may be customers of the entity owning and/or operating the software distribution platform 1405. For example, the entity that owns and/or operates the software distribution platform 1405 may be a developer, a seller, and/or a licensor of software such as the example machine readable instructions 1132 of FIG. 11. The third parties may be consumers, users, retailers, OEMs, etc., who purchase and/or license the software for use and/or re-sale and/or sub-licensing. In the illustrated example, the software distribution platform 1405 includes one or more servers and one or more storage devices. The storage devices store the machine readable instructions 1132, which may correspond to the example machine readable instructions of FIGS. 7-10, as described above. The one or more servers of the example software distribution platform 1405 are in communication with an example network 1410, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 1132 from the software distribution platform 1405. For example, the software, which may correspond to the example machine readable instructions of FIGS. 7-10, may be downloaded to the example programmable circuitry platform 1100, which is to execute the machine readable instructions 1132 to implement the calibration circuitry. In some examples, one or more servers of the software distribution platform 1405 periodically offer, transmit, and/or force updates to the software (e.g., the example machine readable instructions 1132 of FIG. 11) to ensure improvements, patches, updates, etc., are distributed and applied to the software at the end user devices. Although referred to as software above, the distributed “software” could alternatively be firmware.

From the foregoing, it will be appreciated that example systems, apparatus, articles of manufacture, and methods have been disclosed that enable low-cost off-the-shelf camera devices to be calibrated for use in mixed media applications, such as virtual reality and augmented reality applications. Additionally, examples disclosed herein enable and/or otherwise facilitate camera calibration procedures without using any calibration patterns (e.g., visual patterns), which are typically specifically designed for a particular camera by a particular camera manufacturer. Such calibration patterns (e.g., checkboards and/or fiducial grids printed on card-stock) are subject to loss, misplacement, damage, and require user interaction to function. Examples disclosed herein utilize a radius dimension of an elliptical-shaped table (e.g., a circular table, a substantially circular table) and a partial camera view of that table. In the event the table is moved and/or the camera is moved after a first calibration, examples disclosed herein may invoke a re-calibration effort without user involvement. In some examples, re-calibration occurs on a periodic or scheduled basis to accommodate for the possibility that the table has been bumped, re-positioned and/or otherwise moved due to inadvertent human interaction with the table. Disclosed systems, apparatus, articles of manufacture, and methods improve the efficiency of using a computing device by eliminating human error that may cause calibration errors. For instance, human actors (that may be unfamiliar with calibration procedures for a particular camera) are not involved in calibration, thereby improving the accuracy of calibration metrics (e.g., tilt and pan metrics relative to a current camera and table position) by eliminating the possibility of human error. Accordingly, disclosed systems, apparatus, articles of manufacture, and methods are directed to one or more improvement(s) in the operation of a machine such as a computer or other electronic and/or mechanical device.

Example methods, apparatus, systems, and articles of manufacture to calibrate imaging devices are disclosed herein. Further examples and combinations thereof include the following:
Example 1 includes an apparatus, comprising interface circuitry, machine readable instructions, and programmable circuitry to at least one of instantiate or execute the machine readable instructions to segregate an image into regions, binarize the image by associating a first one of the regions with a surface, and associating a second one of the regions with background objects, generate a quadric corresponding to the surface, distinguish a first quantity of pixels from a second quantity of pixels from the binarized image, the first quantity of pixels associated with the first one of the regions and the second quantity of pixels associated with the second one of the regions, adjust parameters of the quadric based on the first quantity of the pixels, and calculate calibration parameters based on the adjusted parameters of the quadric.
Example 2 includes the apparatus as defined in example 1, wherein the programmable circuitry is to mitigate non-homogenous characteristics of the first one of the regions by applying a Gaussian blur filter to the image.
Example 3 includes the apparatus as defined in example 2, wherein the programmable circuitry is to segment objects of the image by applying a mean-shift filter to the image, the mean-shift filter to produce a segmented image.
Example 4 includes the apparatus as defined in example 3, wherein the programmable circuitry is to convert the segmented image to an alternate color space.
Example 5 includes the apparatus as defined in example 4, wherein the alternate color space is a Hue-Saturation-Value (HSV) color space.
Example 6 includes the apparatus as defined in example 1, wherein the programmable circuitry is to randomly or pseudo-randomly acquire a plurality of pixels from the binarized image, respective ones of the randomly or pseudo-randomly acquired pixels tested against boundary-satisfaction rules to distinguish the first quantity of pixels from the second quantity of pixels.
Example 7 includes the apparatus as defined in example 6, wherein the boundary-satisfaction rules are based on an ellipsoid shape.
Example 8 includes the apparatus as defined in example 1, wherein the programmable circuitry is to determine a center of the quadric, determine a lateral angle between the surface and a camera, and determine a top angle between the surface and the camera.
Example 9 includes the apparatus as defined in example 8, wherein the programmable circuitry is to calculate the calibration parameters based on (a) the center of the quadric, (b) the lateral angle and (c) the top angle.
Example 10 includes the apparatus as defined in example 9, wherein the calibration parameters include a tilt metric and a pan metric.
Example 11 includes the apparatus as defined in example 1, wherein the surface is an ellipsoid table.
Example 12 includes the apparatus as defined in example 1, wherein the programmable circuitry is to generate the quadric based on a symmetric matrix having parameters to define the surface.
Example 13 includes a non-transitory machine readable storage medium comprising instructions to cause programmable circuitry to at least segregate an image into regions, identify a first one of the regions as associated with a surface in the image, identify a second one of the regions as associated with background object in the image, generate a quadric, identify a first quantity of pixels and a second quantity of pixels, the first quantity of pixels associated with the first one of the regions and the second quantity of pixels associated with the second one of the regions, train parameters of the quadric based on the first quantity of the pixels, and determine calibration parameters based on the trained parameters of the quadric.
Example 14 includes the non-transitory machine readable storage medium as defined in example 13, wherein the instructions are to cause the programmable circuitry to mitigate non-homogenous characteristics of the first one of the regions by applying a blur filter to the image.
Example 15 includes the non-transitory machine readable storage medium as defined in example 14, wherein the instructions are to cause the programmable circuitry to apply a mean-shift filter to the image, the mean-shift filter to produce a segmented image.
Example 16 includes the non-transitory machine readable storage medium as defined in example 15, wherein the instructions are to cause the programmable circuitry to convert the segmented image to an alternate color space.
Example 17 includes the non-transitory machine readable storage medium as defined in example 16, wherein the alternate color space is a Hue-Saturation-Value (HSV) color space.
Example 18 includes the non-transitory machine readable storage medium as defined in example 13, wherein the instructions are to cause the programmable circuitry to acquire, randomly or pseudo-randomly, a plurality of pixels from the image, and distinguish the first quantity of pixels from the second quantity of pixels by testing the plurality of pixels against boundary-satisfaction rules.
Example 19 includes the non-transitory machine readable storage medium as defined in example 18, wherein the boundary-satisfaction rules are based on an ellipsoid shape.
Example 20 includes the non-transitory machine readable storage medium as defined in example 13, wherein the instructions are to cause the programmable circuitry to calculate a center of the quadric, calculate a lateral angle between the surface and a camera, and calculate a top angle between the surface and the camera.
Example 21 includes the non-transitory machine readable storage medium as defined in example 20, wherein the instructions are to cause the programmable circuitry to calculate the calibration parameters based on (a) the center of the quadric, (b) the lateral angle and (c) the top angle.
Example 22 includes the non-transitory machine readable storage medium as defined in example 21, wherein the calibration parameters include a tilt metric and a pan metric.
Example 23 includes the non-transitory machine readable storage medium as defined in example 13, wherein the surface is an ellipsoid table.
Example 24 includes the non-transitory machine readable storage medium as defined in example 13, wherein the instructions are to cause the programmable circuitry to generate the quadric based on a symmetric matrix having parameters to define an ellipsoid surface.
Example 25 includes the non-transitory machine readable storage medium as defined in example 13, wherein the instructions are to cause the programmable circuitry to apply the blur as a Guassian blur.
Example 26 includes a method comprising segregating an image into regions, identifying a first one of the regions as associated with a surface in the image, identifying a second one of the regions as associated with background object in the image, generating a quadric, identifying a first quantity of pixels and a second quantity of pixels, the first quantity of pixels associated with the first one of the regions and the second quantity of pixels associated with the second one of the regions, training parameters of the quadric based on the first quantity of the pixels, and determining calibration parameters based on the trained parameters of the quadric.
Example 27 includes the method as defined in example 26, further including reducing non-homogenous characteristics of the first one of the regions by applying a blur filter to the image.
Example 28 includes the method as defined in example 27, further including segmenting the image by applying a mean-shift filter to the image.
Example 29 includes the method as defined in example 28, further including converting the segmented image to an alternate color space.
Example 30 includes the method as defined in example 29, wherein the alternate color space is a Hue-Saturation-Value (HSV) color space.
Example 31 includes the method as defined in example 26, further including acquiring, randomly or pseudo-randomly, a plurality of pixels from the image, and distinguishing the first quantity of pixels from the second quantity of pixels by testing the plurality of pixels against boundary-satisfaction rules.
Example 32 includes the method as defined in example 31, wherein the boundary-satisfaction rules are based on an ellipsoid shape.
Example 33 includes the method as defined in example 26, further including determining a center of the quadric, determining a lateral angle between the surface and a camera, and determining a top angle between the surface and the camera.
Example 34 includes the method as defined in example 33, further including determining the calibration parameters based on (a) the center of the quadric, (b) the lateral angle and (c) the top angle.
Example 35 includes the method as defined in example 34, wherein the calibration parameters include a tilt metric and a pan metric.
Example 36 includes the method as defined in example 26, wherein the surface is an ellipsoid table.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

1. An apparatus, comprising:
interface circuitry;
machine readable instructions; and
programmable circuitry to at least one of instantiate or execute the machine readable instructions to:
segregate an image into regions;
binarize the image by:
associating a first one of the regions with a surface; and
associating a second one of the regions with background objects;
generate a quadric corresponding to the surface;
distinguish a first quantity of pixels from a second quantity of pixels from the binarized image, the first quantity of pixels associated with the first one of the regions and the second quantity of pixels associated with the second one of the regions;
adjust parameters of the quadric based on the first quantity of the pixels; and
calculate calibration parameters based on the adjusted parameters of the quadric.

2. The apparatus as defined in claim 1, wherein the programmable circuitry is to mitigate non-homogenous characteristics of the first one of the regions by applying a Gaussian blur filter to the image.

3. The apparatus as defined in claim 2, wherein the programmable circuitry is to segment objects of the image by applying a mean-shift filter to the image, the mean-shift filter to produce a segmented image.

4. The apparatus as defined in claim 3, wherein the programmable circuitry is to convert the segmented image to an alternate color space.

5. The apparatus as defined in claim 4, wherein the alternate color space is a Hue-Saturation-Value (HSV) color space.

6. The apparatus as defined in claim 1, wherein the programmable circuitry is to randomly or pseudo-randomly acquire a plurality of pixels from the binarized image, respective ones of the randomly or pseudo-randomly acquired pixels tested against boundary-satisfaction rules to distinguish the first quantity of pixels from the second quantity of pixels.

7. The apparatus as defined in claim 6, wherein the boundary-satisfaction rules are based on an ellipsoid shape.

8. The apparatus as defined in claim 1, wherein the programmable circuitry is to:
determine a center of the quadric;
determine a lateral angle between the surface and a camera; and
determine a top angle between the surface and the camera.

9. The apparatus as defined in claim 8, wherein the programmable circuitry is to calculate the calibration parameters based on (a) the center of the quadric, (b) the lateral angle and (c) the top angle.

10-12. (canceled)

13. A non-transitory machine readable storage medium comprising instructions to cause programmable circuitry to at least:
segregate an image into regions;
identify a first one of the regions as associated with a surface in the image;
identify a second one of the regions as associated with background object in the image;
generate a quadric;
identify a first quantity of pixels and a second quantity of pixels, the first quantity of pixels associated with the first one of the regions and the second quantity of pixels associated with the second one of the regions;
train parameters of the quadric based on the first quantity of the pixels; and
determine calibration parameters based on the trained parameters of the quadric.

14. The non-transitory machine readable storage medium as defined in claim 13, wherein the instructions are to cause the programmable circuitry to mitigate non-homogenous characteristics of the first one of the regions by applying a blur filter to the image.

15-17. (canceled)

18. The non-transitory machine readable storage medium as defined in claim 13, wherein the instructions are to cause the programmable circuitry to:
acquire, randomly or pseudo-randomly, a plurality of pixels from the image; and
distinguish the first quantity of pixels from the second quantity of pixels by testing the plurality of pixels against boundary-satisfaction rules.

19. The non-transitory machine readable storage medium as defined in claim 18, wherein the boundary-satisfaction rules are based on an ellipsoid shape.

20. The non-transitory machine readable storage medium as defined in claim 13, wherein the instructions are to cause the programmable circuitry to:
calculate a center of the quadric;
calculate a lateral angle between the surface and a camera; and
calculate a top angle between the surface and the camera.

21. The non-transitory machine readable storage medium as defined in claim 20, wherein the instructions are to cause the programmable circuitry to calculate the calibration parameters based on (a) the center of the quadric, (b) the lateral angle and (c) the top angle.

22. The non-transitory machine readable storage medium as defined in claim 21, wherein the calibration parameters include a tilt metric and a pan metric.

23. The non-transitory machine readable storage medium as defined in claim 13, wherein the surface is an ellipsoid table.

24. The non-transitory machine readable storage medium as defined in claim 13, wherein the instructions are to cause the programmable circuitry to generate the quadric based on a symmetric matrix having parameters to define an ellipsoid surface.

25. The non-transitory machine readable storage medium as defined in claim 13, wherein the instructions are to cause the programmable circuitry to apply the blur as a Guassian blur.

26. A method comprising:
segregating an image into regions;
identifying a first one of the regions as associated with a surface in the image;
identifying a second one of the regions as associated with background object in the image;
generating a quadric;
identifying a first quantity of pixels and a second quantity of pixels, the first quantity of pixels associated with the first one of the regions and the second quantity of pixels associated with the second one of the regions;
training parameters of the quadric based on the first quantity of the pixels; and
determining calibration parameters based on the trained parameters of the quadric.

27-36. (canceled)
